(19) United States
(12) Patent Application Publication
(10) Pub. No.: US 2021/0185974 A1
(43) Pub. Date: Jun. 24, 2021

(54) LITTERBOX KIT

(71) Applicant: Tuft and Paw Incorporated, Vancouver (CA)

(72) Inventors: Jackson Cunningham, Vancouver (CA); Steve Suchy, Vancouver (CA)

(73) Assignee: Tuft and Paw Incorporated, Vancouver (CA)

(21) Appl. No.: 17/122,922

(22) Filed: Dec. 15, 2020

Related U.S. Application Data
(60) Provisional application No. 62/949,936, filed on Dec. 18, 2019.

(51) Int. Cl. A01K 1/01; A47L 13/52; A47L 25/00

(52) U.S. Cl. CPC A01K 1/011; A47L 25/00; A47L 13/52

(57) ABSTRACT

A litter box assembly comprising a litter section conjoined with a tool section for storage of one or more litter box tools.

### CROSS-REFERENCE TO RELATED APPLICATIONS

Priority claimed to Provisional Application No. 62/949,936

### STATEMENT REGARDING FEDERALLY SPONSORED RESEARCH OR DEVELOPMENT

Not Applicable

### TECHNICAL FIELD

The invention relates to the field of litter boxes for pets, particularly cats. Priority is claimed to provisional application No. 62/949,936, which is incorporated by reference herein.

### BACKGROUND OF THE INVENTION

A litter box (or “litterbox”), also referred to as a sandbox, cat box, litter tray, or litter pan, is feces and urine collection box for cats and other small pets, such as rabbits, ferrets, or small dogs. They are generally provided for pets that are free to roam around a dwelling but cannot or do not always go outside to excrete waste because of predators, inclement weather, lack of available supervision, or other circumstances.

Litter boxes are most commonly used for household cats. In the wild, cats preferentially excrete in soft or sandy soil for easy burial, using their paws in a backward sweeping motion to cover their feces. To stimulate this instinctive desire, a litter box's bottom is typically filled with a few inches of litter box filler, often referred to as “kitty” or “cat” litter. Litter box filler is typically loose, granular material that absorbs moisture and odors and adheres to feces, permitting easy removal. The filler helps to satisfy a cat's instinctive desire to hide their scent by allowing them to bury their waste. The most common material for kitty litter is clay, although recycled paper pellets, silica-based crystals, and other materials are also used. Litter box filler may contain baking soda or other odor-absorbent ingredients.

Perhaps the most common, simplest, and least expensive form of litter box is a basic plastic tub, the dimensions of which can vary from around a foot square to two feet or more on a side. The walls of the tub must be of sufficient height to hold the litter and permit burial of the feces without undue spill-over, while being low enough to accommodate the particular size and mobility of a pet.

It is desirable to timely remove waste from a litter box to prevent build-up and excess odor while also not having to frequently replace the litter box filler. For this purpose it is common to employ tools or implements such as a scoop and dustpan to remove solid waste while keeping most of the litter material in the box. Such implements are ideally stored in a convenient location near the litter box, which can present a challenge because there may be no convenient and accessible location nearby, and the implements may become soiled and shed waste, are often unsightly, and can be mislaid.

While open plastic tubs meet the basic requirements of a litter box, they are hardly ideal. They are typically flimsy, which can hamper litter removal and replacement, and generally unsightly, clashing with more refined furnishings. They also fail to accommodate the need for convenient access to tools or implements for litter box upkeep. Therefore, there is a need for functional and yet aesthetically pleasing litter box that offers convenient storage for and access to cleaning implements. It further desirable for the litter box itself to be sturdy, easy to clean, and conducive to the removal and replacement of the litter after it becomes soiled.

### SUMMARY OF THE INVENTION

Applicant has invented an integrated litter box kit or assembly that avoids many of the shortcomings of previous litter boxes. Specifically, the litter box of the present invention includes an integrated compartment for the storage of one or more tools or implements and an overall construction conducive to waste remove, ease of cleaning, aesthetic refinement, and litter disposal and replacement.

In one embodiment, the tub of the litter box is injection-molded from a single mold into a two separate sections, a larger section for holding the litter and a narrower section serving as a receptacle for one or more tools, such as a scoop and dustpan. An insert may be provided further dividing the narrow receptacle section into two or more smaller sections housing different tools. For example, one section may contain a scoop for waste and the other an integrated dustpan and brush for disposing of the waste and tidying up afterwards.

Additionally, the underside of the molded wall separating the litter section and the tool section can be a hollow cavity that serves as a handle for transport of the litter box and as a grip for more convenient removal of the litter filler. In a preferred embodiment, the walls of the litter box are double-walled, such that the interior walls of the litter section and the tool section are separate from the external walls of the entire assembly. Additionally, the conjoined interior walls of the tool section and the litter section form a cavity within the underside of the integrated unit. Double-walled construction imparts additional rigidity and aesthetic appeal to box.

It has been discovered that molding the litter box from relatively sturdy recycled plastic of uniform thickness adds to its rigidity and functionality for removal and replacement of litter and general cleaning as well as overall aesthetic impression. Additionally, forming the litter box from a single mold increases manufacturing efficiency and reduces complexity and assembly costs.

In a preferred embodiment the molded underside of the litter box may be fitted with a ring of silicone rubber or thermoplastic elastomer that helps keep the box securely planted to the floor and provides additional grip when moving or cleaning the box. This ring can be separately molded or manufactured to fit around the perimeter and, optionally, including the cavity between the litter section and the tool section.

In a preferred embodiment, the walls of the litter box are 6 inches high. This allows for almost all cats to get conveniently in and out while also being able to view their surroundings. Further, in a preferred embodiment the interior of the litter section 20 inches in length by 14 inches in width, and the exterior dimensions are 24 inches in length by 16 inches in width. These dimensions have been determined to be suitable for most cats and small pets while limiting the overall volume of litter and size of the box so that it is manageable and unobtrusive.

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 is a perspective blowout view of a litter box and accessories according to an aspect of the present disclosure.

FIG. 2 is a top view of a litter box and accessories according to an aspect of the present disclosure.

FIG. 3 is a perspective view of a litter box and accessories according to an aspect of the present disclosure.

FIG. 4 is a side view of a litter box and accessories according to an aspect of the present disclosure.

FIG. 5 is a front view of a litter box and accessories according to an aspect of the present disclosure.

FIG. 6 is a cross sectional side view of a litter box according to an aspect of the present disclosure, including a cross section of the flexible ring.

FIG. 7 is a side perspective view of a litter box and accessories according to an aspect of the present disclosure.

FIG. 8 is a perspective view of a litter box according to an aspect of the present disclosure without accessories.

FIG. 9 is a perspective view of the bottom of a litter box according to an aspect of the present disclosure.

### DETAILED DESCRIPTION OF THE DRAWINGS

A litter box constructed in accord with an embodiment of the invention with and without accessories is illustrated in the drawings.

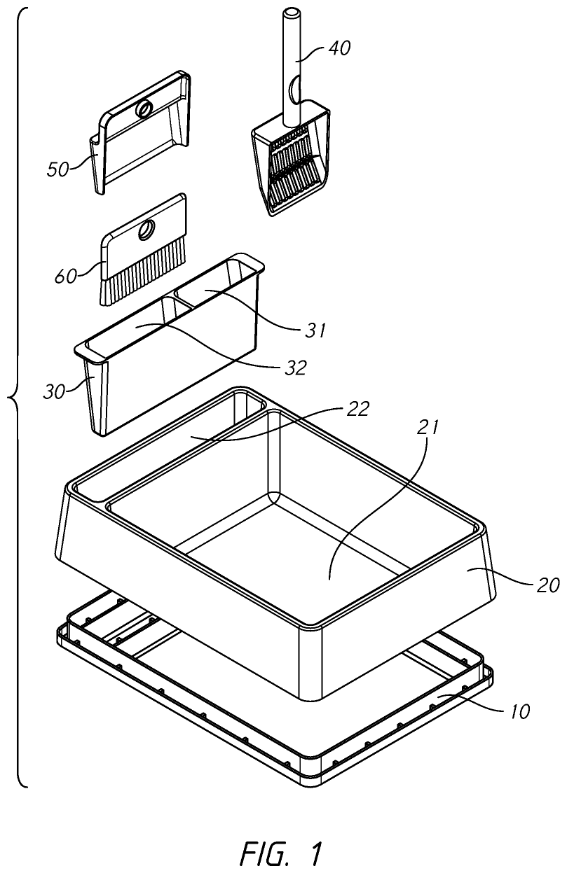

FIG. 1 is a perspective blowout view of an embodiment of the integrated litter box and accessories. The litter section 21 and tool section 22 are part of the integrated litter box assembly 20. A flexible ring 10 fits around the perimeter of the base of the integrated litter 21 and tool 22 sections between the interior and exterior walls. The flexible ring 10, made of rubber, silicone, or similar flexible material, helps secure the unit to the floor and provides a grip for changing or cleaning the litter.

The tool section 22 can serve as a unitary storage space or can be divided into two or more sections 31 and 32 to store tools or accessories by means of a divider or holder 30 that slots into the tool section 22. The holder 30 may be removeable for easy cleaning and upkeep.

Accessories or tools such as a litter scoop 40 and integrated dust pan 50 and brush 60 can be stored in the tool section 22 or in a holder 30 seated in the tool section.

The integrated assembly allows for ease of use and cleaning, convenient litter and feces disposal, and superior functionality that meets the needs of contemporary pet owners.

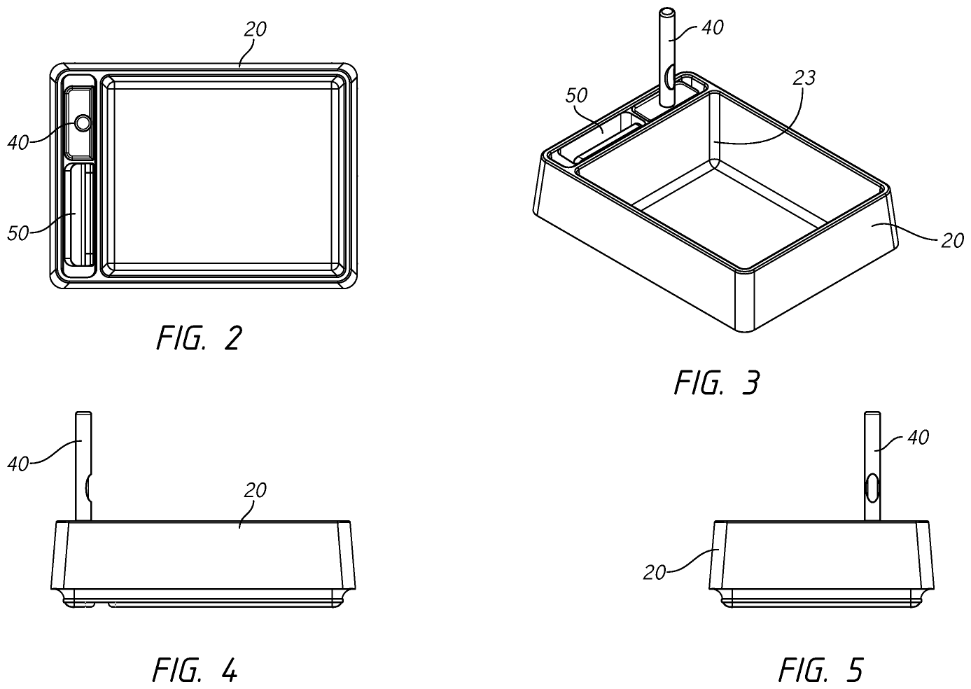

FIGS. 2-5 illustrate other views of the litter box.

FIG. 2 is a top down view showing tools 40 and 50 seated in the tools section 22.

FIG. 3 illustrates a perspective view of the litter box 20 and accessories 40 and 50 where the internal contours 23 of the litter section are rounded to conform to the contours of a litter scoop 40 for convenient scooping of feces deposited in the cat litter.

FIGS. 4 and 5 illustrate side and front views of the integrated letter box and depict angled external walls of the unit.

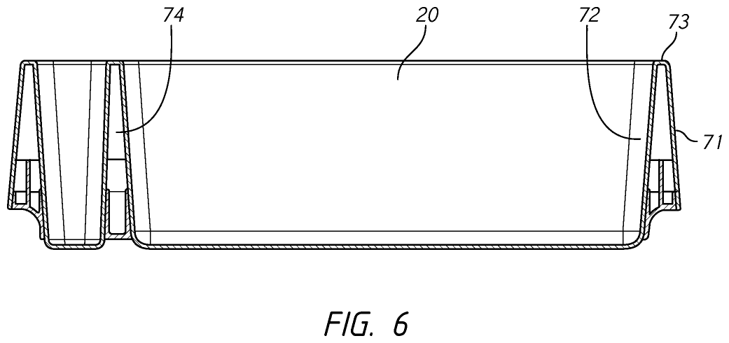

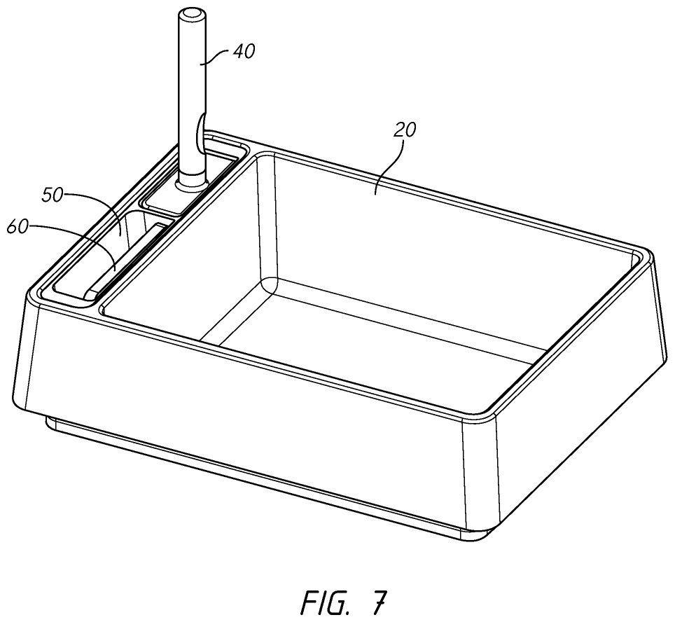

The double-wall construction is depicted in the cross section view of FIG. 6, where internal 72 and external walls 71 of the litter and tool sections are angled and join at a flat section 73 at the top of unit. Double-walled construction imparts stability and rigidity to the unit and contributes to its aesthetics and provides a gap for attachment of the flexible ring.

The angular double-wall construction is also present in the wall separating the litter and tool sections 74. This again imparts stability and rigidity to the unit, provides a gap for the flexible ring, and creates a handhold for convenient handling of the unit when replacing litter and cleaning. It is possible to mold the integrated assembly with double walls from a single mold, which reduces production cost and increases efficiency.

FIG. 7 depicts an embodiment where litter box accessories seated in the integrated unit.

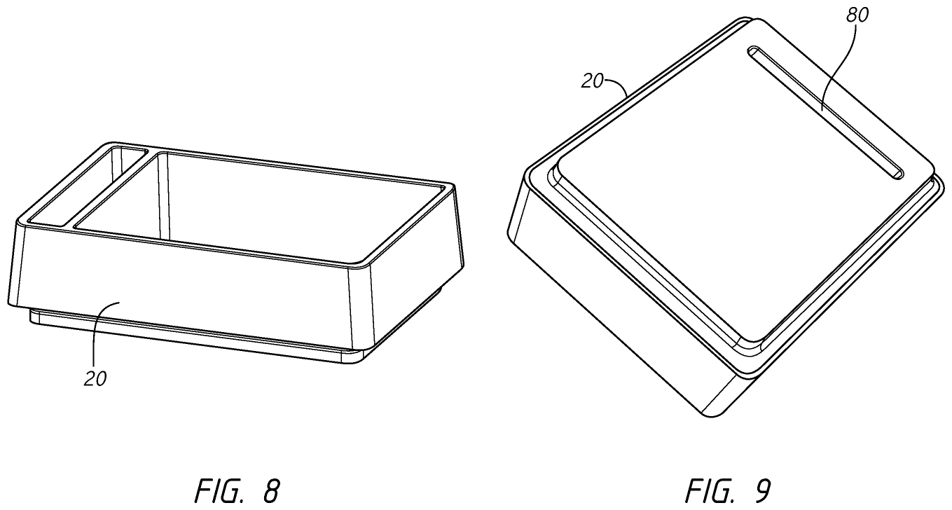

FIG. 8 illustrates an embodiment of the integrated litter box absent any tools or accessories.

FIG. 9 depicts the underside of the unit showing the double-walled construction and the cavity 80 between the tool and litter sections that imparts rigidity and can be used as a convenient handle.

Modifications and substitution by one of ordinary skill in the art are considered to be within the scope of the present invention, which is not limited except by the following claims.

What is claimed is:

1. A litter box assembly comprising:
a litter section conjoined with a tool section for storage of one or more litter box tools.

2. The litter box assembly of claim 1 wherein the litter section and tool section are molded from a single mold.

3. The litter box assembly of claim 2 wherein the internal and external walls of the litter section and tool section are distinct and join at the top of the integrated litter box, forming a double-walled assembly.

4. The litter box assembly of claim 3 wherein the litter section and tool section are separated by a double-wall, the underside of which forms a cavity that can serve as a handle for lifting or manipulation of the litter box.

5. The litter box assembly of claim 4 wherein the tool section is divided into two or more sections via molding or inclusion of a divider separating the tool section into two or more compartments to permit storage of two or more tools in separate compartments.

6. The litter box assembly of claim 5 wherein the connection between the interior walls and interior floor of the litter section is rounded.

7. The litter box assembly of claim 4 wherein a flexible ring is fitted around the base of the litter box assembly.

8. The litter box assembly of claim 5 wherein tools are included with the assembly for storage in the tool section.

9. The litter box assembly of claim 8 wherein the included tools comprise a scoop and a dustpan.

10. The litter box assembly of claim 9 wherein the dustpan is formed to permit integration with a brush to permit storage of both tools in a single section.

11. The litter box assembly of claim 4 where the interior walls of the litter section are vertical.

12. The litter box of claim 9 wherein the tools and the litter box are fashioned from the same type of plastic.
